(19) United States
(12) Patent Application Publication
(10) Pub. No.: US 2016/0249050 A1
(43) Pub. Date: Aug. 25, 2016

(54) BLOCK STRUCTURE DECISION CIRCUIT AND BLOCK STRUCTURE DECISION METHOD

(71) Applicant: NEC CORPORATION, Minato-ku, Tokyo (JP)

(72) Inventors: SEIYA SHIBATA, Tokyo (JP); KEIICHI CHONO, Tokyo (JP)

(73) Assignee: NEC CORPORATION, Minato-ku, Tokyo (JP)

(21) Appl. No.: 15/025,628

(22) PCT Filed: Sep. 30, 2014
(86) PCT No.: PCT/JP2014/004996

§ 371 Date: Mar. 29, 2016

(30) Foreign Application Priority Data
Oct. 22, 2013 (JP) 2013-218825

(51) Int. Cl. H04N 19/119; H04N 19/176; H04N 19/96; H04N 19/156

(52) U.S. Cl. CPC H04N 19/119; H04N 19/156; H04N 19/176; H04N 19/96

(57) ABSTRACT

A block structure decision circuit includes: a storage unit 11 in which constraint data relating to a constraint on processing time for processing the block structure is set; a constraint determination unit 12 for determining whether or not the decided block structure infringes the constraint specified by the constraint data; and a block structure modification unit 13 for modifying the decided block structure not to infringe the constraint, in the case where the constraint determination unit 12 determines that the decided block structure infringes the constraint.

### TECHNICAL FIELD

The present invention relates to a block structure decision circuit and block structure decision method for deciding the structure of a block so as to ensure that processing the block is completed within predetermined processing time.

### BACKGROUND ART

Non Patent Literature (NPL) 1 describes High Efficiency Video Coding (HEVC) which is a video coding system based on ITU-T Recommendation H.265.

In HEVC, each frame of digitized video is divided into coding tree units (CTUs), and each CTU is coded in raster scan order. Each CTU is divided into coding units (CUs) and coded, in a quadtree structure. Each CU is divided into prediction units (PUs) and predicted. The prediction error of each CU is divided into transform units (TUs) and frequency-transformed, in a quadtree structure. A CU of the largest size is referred to as a “largest CU” (largest coding unit: LCU), and a CU of the smallest size is referred to as a “smallest CU” (smallest coding unit: SCU).

Each CU is prediction-coded by intra prediction or inter-frame prediction (inter prediction).

FIG. 12 is an explanatory diagram illustrating a CU division example in the case where the CTU size is 64×64 (64 pixels×64 pixels). (A) of FIG. 12 illustrates an example of the partitioning shape (hereafter also referred to as “block structure”), and (B) of FIG. 12 illustrates a CU quadtree structure corresponding to the partitioning shape illustrated in (A) of FIG. 12).

Each CU is divided into TUs in a quadtree structure. The way of division is the same way as the CU division illustrate in (A) of FIG. 12. The layer (depth) illustrated in (B) of FIG. 12 is derived by focusing on the TU division.

When the division is performed in the case of coding by the intra prediction, TUs are sequentially divided with the PU which is a block having the same size as the CU or obtained by dividing the CU into four parts, as a starting point. In inter prediction coding, the TU partitioning is sequentially performed starting from the CU.

The following describes the structure and operation of a typical video coding device that receives each CU of each frame of digitized video as an input image and outputs a bitstream, with reference to FIG. 13.

FIG. 13 is a block diagram depicting an example of the typical video coding device. The video coding device illustrated in FIG. 13 includes a transformer 301, a quantizer 302, an entropy coding unit 303, an inverse quantizer/inverse transformer 304, a buffer 305, a prediction unit 306, and a block structure decision unit 317.

The block structure decision unit 317 calculates the coding cost of a CU including a plurality of TUs. The coding cost reflects a code amount-related value and a coding distortion (correlated with image quality). As an example, the block structure decision unit 317 uses the following rate distortion (RD) cost.

Cost=D+λ·R.

Here, D is a coding distortion, R is a code amount that also takes into account a transform coefficient, and λ is a Lagrange multiplier.

The block structure decision unit 317 decides a CU quadtree structure/PU partitioning shape/TU quadtree structure so as to enhance coding efficiency according to image features, for each CTU.

The prediction unit 306 generates a prediction signal for the input image signal of the CU, based on the CU quadtree structure and PU partitioning shape decided by the block structure decision unit 317. The prediction signal is generated by intra prediction or inter prediction.

The transformer 301 frequency-transforms a prediction error image (prediction error signal) obtained by subtracting the prediction signal from the input image signal, based on the TU quadtree structure decided by the block structure decision unit 317. In the transform coding of the prediction error signal, the transformer 301 uses an orthogonal transform of 4×4, 8×8, 16×16, or 32×32 block size based on frequency transform. In detail, for the 4×4 TUs of the luminance component of the CU which is intra-coded or inter-coded, the transformer 301 uses a discrete sine transform (DST) approximated by integer arithmetic (i.e. having integer accuracy). For the other TUs, the transformer 301 uses a discrete cosine transform (DCT) approximated by integer arithmetic (i.e. having integer accuracy) corresponding to the block size.

The quantizer 302 quantizes the transform coefficient (orthogonal transform coefficient) supplied from the transformer 301. The inverse quantizer/inverse transformer 304 inverse-quantizes the transform coefficient. The inverse quantizer/inverse transformer 304 further inverse-transforms the inverse-quantized transform coefficient. The prediction signal is added to the prediction error image obtained by the inverse transform, and the result is supplied to the buffer 305. The buffer 305 stores the image as a reference image.

### CITATION LIST

### Non Patent Literature

NPL 1: ITU-T Recommendation H.265 High efficiency video coding, April 2013

### SUMMARY OF INVENTION

### Technical Problem

Intra prediction is prediction for generating a prediction image from a reference image of a frame to be coded. NPL 1 defines 33 types of angular intra prediction illustrated in FIG. 14. In angular intra prediction, reference pixels near a block to be coded are used for extrapolation in any of the 33 directions illustrated in FIG. 14, to generate an intra prediction signal (prediction pixel). In addition to the 33 types of angular intra prediction, NPL 1 defines DC intra prediction for averaging reference pixels near a block to be coded, and planar intra prediction for linear interpolating reference pixels near a block to be coded.

In FIG. 14, each rectangle in the uppermost row and leftmost column represents a reference pixel. The number in each rectangle indicates coordinates, and each arrow indicates a prediction direction. The number beside each arrow indicates a prediction mode (hereafter also referred to as a “mode”).

FIG. 15 is an explanatory diagram illustrating adjacent blocks adjacent to a prediction target block (prediction block). In the adjacent blocks (8×8 in the example illustrated in FIG. 15), the pixels located at the right end and at the lower end are reference pixels of the prediction block. Therefore, unless these pixels are stored in the buffer 305, coding of the prediction block cannot be started. Hereinafter, this is referred to as that the prediction block has a “dependence” with the adjacent blocks.

The prediction block has the dependence with the adjacent blocks and therefore, for example, top-left four blocks (four 16×16 blocks) in (A) of FIG. 12 are not allowed to be intra-encoded simultaneously.

As a result, the above four blocks are not allowed to be processed simultaneously in the subsequent process (process in the part enclosed by a dashed line in FIG. 13), either. The part enclosed by the dashed lines in FIG. 13 is hereafter also referred to as the “compression processing unit”.

There is a constraint on the processing time of the compression processing unit. For instance, there is a constraint on the processing time depending on the input video format.

The block structure decision unit 317 decides a TU quadtree structure so as to enhance coding efficiency, as mentioned above. However, a specific partitioning shape may infringe the processing time constraint (may violate the processing time constraint).

The TU block size is 4×4, 8×8, 16×16, or 32×32. Typically, when the block size is larger, the processing time per pixel is shorter. For example, the time for processing one 16×16 block is shorter than the time for processing four 8×8 blocks.

Accordingly, in the case where the partitioning shape decided by the block structure decision unit 317 infringes the processing time constraint, the decided shape may be modified so as not to include small-size blocks. For example, the shape is modified so as not to include 4×4 blocks.

Increasing the block size in the CU, however, causes a decrease in image quality. Besides, while a compression processing unit capable of parallel processing is used to improve the processing speed of the whole video coding device in some cases, simply increasing the block size may cause a decrease in efficiency of parallel processing. This is because simply integrating a plurality of small blocks into a large block may lead to a situation where a plurality of small blocks that can be processed in parallel no longer exist. In other words, there is a possibility that a plurality of small blocks that can be processed in parallel are integrated into a large block despite the fact that a decrease in image quality is rather prevented by leaving the plurality of small blocks that can be processed in parallel intact. Here, the processing time may not be significantly different between in the case where the plurality of small blocks that can be processed in parallel are left intact and in the case where the plurality of small blocks are integrated into a large block. There is thus a possibility of degrading image quality despite a lack of improvement in processing time.

The present invention therefore has an object of providing a block structure decision circuit and block structure decision method that does not infringe the processing time constraint while preventing a decrease in image quality.

### Solution to Problem

A block structure decision circuit according to the present invention is a block structure decision circuit for deciding a block structure including units formed by hierarchically dividing a block, the block structure decision circuit including: a storage unit in which constraint data relating to a constraint on processing time for processing the block structure is set; a constraint determination unit which determines whether or not the decided block structure infringes the constraint specified by the constraint data; and a block structure modification unit which modifies the decided block structure not to infringe the constraint, in the case where the constraint determination unit determines that the decided block structure infringes the constraint.

A block structure decision method according to the present invention is a block structure decision method for deciding a block structure including units formed by hierarchically dividing a block, the block structure decision method including: setting constraint data relating to a constraint on processing time for processing the block structure, in a storage unit beforehand; determining whether or not the decided block structure infringes the constraint specified by the constraint data; and modifying the decided block structure not to infringe the constraint, in the case of determining that the decided block structure infringes the constraint.

### Advantageous Effects of Invention

According to the present invention, the processing time constraint is not infringed while preventing a decrease in image quality.

### BRIEF DESCRIPTION OF DRAWINGS

FIG. 1 It depicts a block diagram depicting an exemplary embodiment of a block structure decision circuit.

FIG. 2 It depicts a conceptual diagram for describing the operation of the block structure decision circuit.

FIG. 3 It depicts a diagram for describing dependence between blocks.

FIG. 4 It depicts is a flowchart depicting the operation of a utilized shape decision unit in Exemplary Embodiment 1.

FIG. 5 It depicts an explanatory diagram depicting an example of the progress of the process by the utilized shape decision unit.

FIG. 6 It depicts a flowchart depicting the operation of the utilized shape decision unit in Exemplary Embodiment 2.

FIG. 7 It depicts a block diagram depicting another embodiment of the block structure decision circuit.

FIG. 8 It depicts a diagram for describing processing time reductions.

FIG. 9 It depicts is a flowchart depicting the operation of the utilized shape decision unit in Exemplary Embodiment 3.

FIG. 10 It depicts is a flowchart depicting the operation of the utilized shape decision unit in Exemplary Embodiment 4.

FIG. 11 It depicts is a block diagram depicting main parts of the block structure decision circuit according to the present invention.

FIG. 12 It depicts is an explanatory diagram depicting an example of CU partitioning.

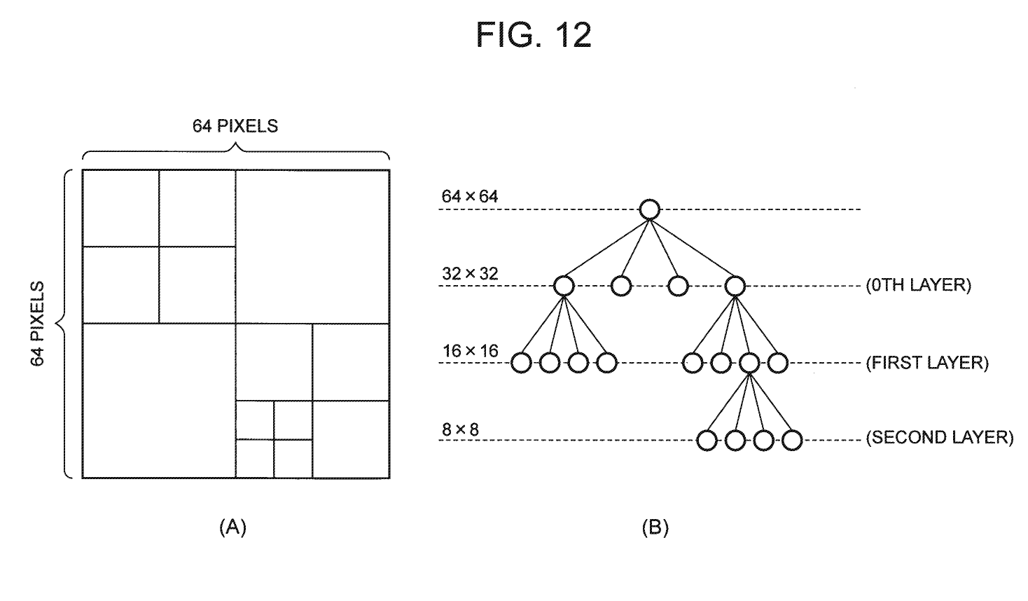

FIG. 13 It depicts an explanatory diagram depicting the structure of a typical video coding device.

FIG. 14 It depicts is an explanatory diagram depicting an example of 33 types of angular intra prediction.

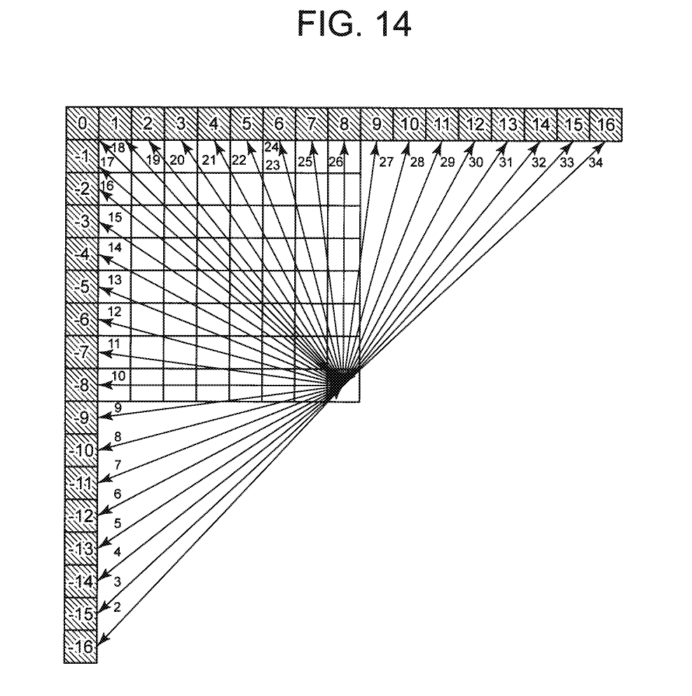

FIG. 15 It depicts is an explanatory diagram depicting an adjacent block which is adjacent to a prediction block.

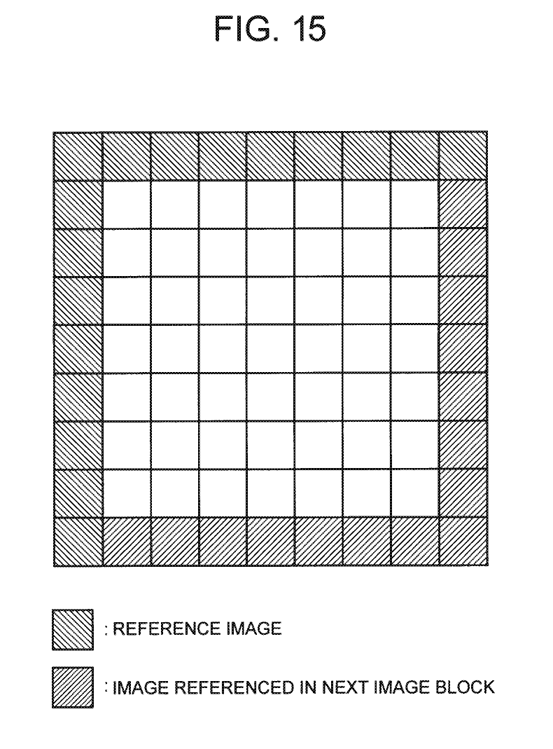

### DESCRIPTION OF EMBODIMENT

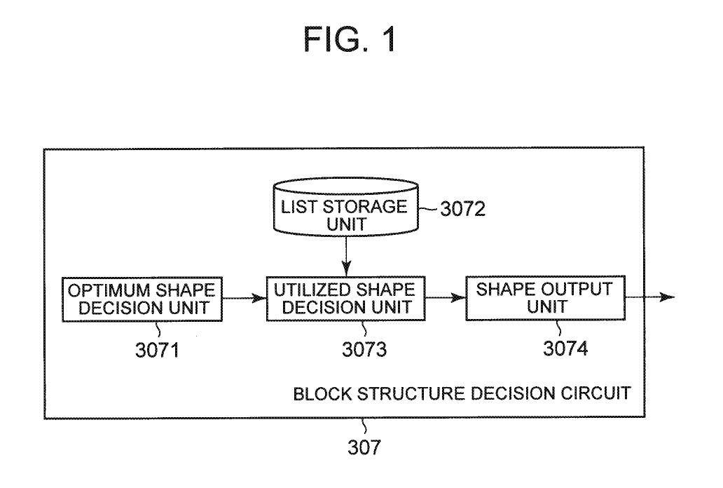

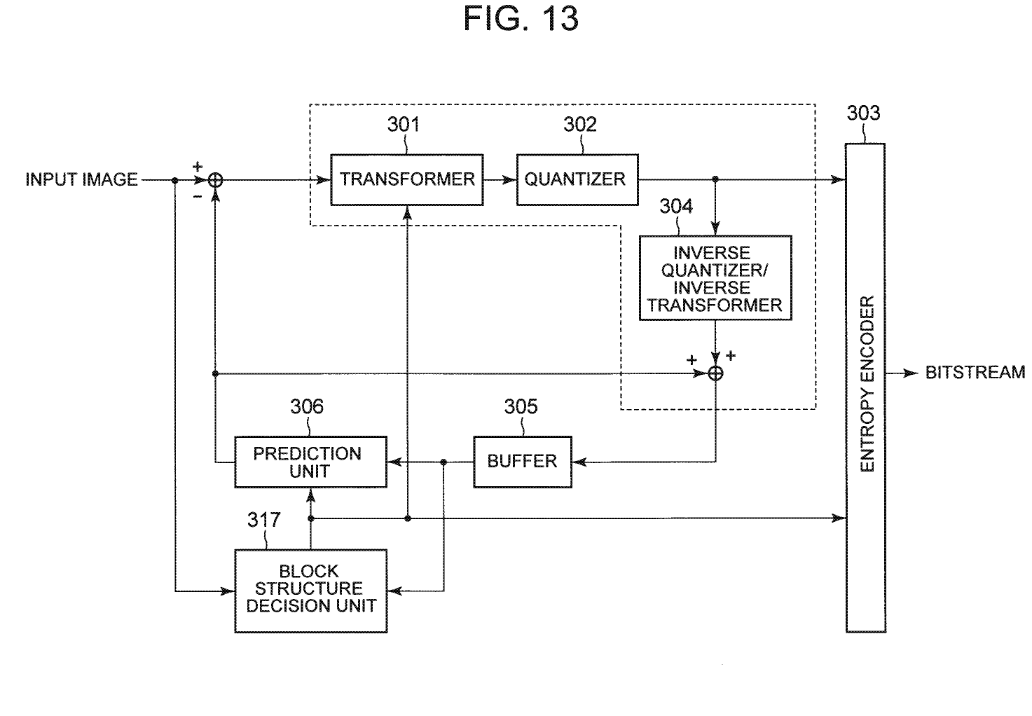

FIG. 1 is a block diagram depicting an exemplary embodiment of a block structure decision circuit according to the present invention. A block structure decision circuit 307 illustrated in FIG. 1 includes: an optimum shape decision unit 3071, a list storage unit 3072 storing a prohibited partitioning list, a utilized shape decision unit 3073, and a shape output unit 3074. The block structure decision circuit 307 is applicable to the video coding circuit illustrated as an example in FIG. 13. In the application, the block structure decision circuit 307 is implemented in place of the block structure decision unit 317.

The prohibited partitioning list has partitioning prohibition data indicating such a shape that makes it impossible for the compression processing unit not to infringe the processing time constraint. The partitioning prohibition data is set in the list storage unit 3072 beforehand. For example, the list storage unit 3072 is a read only memory (ROM) device in which the partitioning prohibition data is stored, or a nonvolatile random access memory (RAM) in which the partitioning prohibition data is stored.

A TU quadtree structure (corresponding to a partitioning shape) can be expressed as data of a bit string. As an example, the TU quadtree structure can be expressed by an 84-bit value. In detail, given that a LCU (64×64 block) has four 32×32 blocks, 4 bits are assigned to four 32×32 blocks each to indicate whether or not the 32×32 block is divided into 16×16 blocks. 16 bits are assigned to sixteen 16×16 blocks each to indicate whether or not the 16×16 block is divided into 8×8 blocks. 64 bits are assigned to sixty-four 8×8 blocks each to indicate whether or not the 8×8 block is divided into 4×4 blocks. For instance, “1” is set in the case where the block is divided, and “0” is set in the case where the block is not divided (“1” and “0” may be reversed).

Meanwhile, no bit is assigned to dividing a LCU (64×64 block) into four 32×32 blocks, as dividing a LCU into 32×32 blocks is mandatory.

Thus, the prohibited partitioning list has one or more pieces of 84-bit partitioning prohibition data each indicating a prohibited partitioning shape.

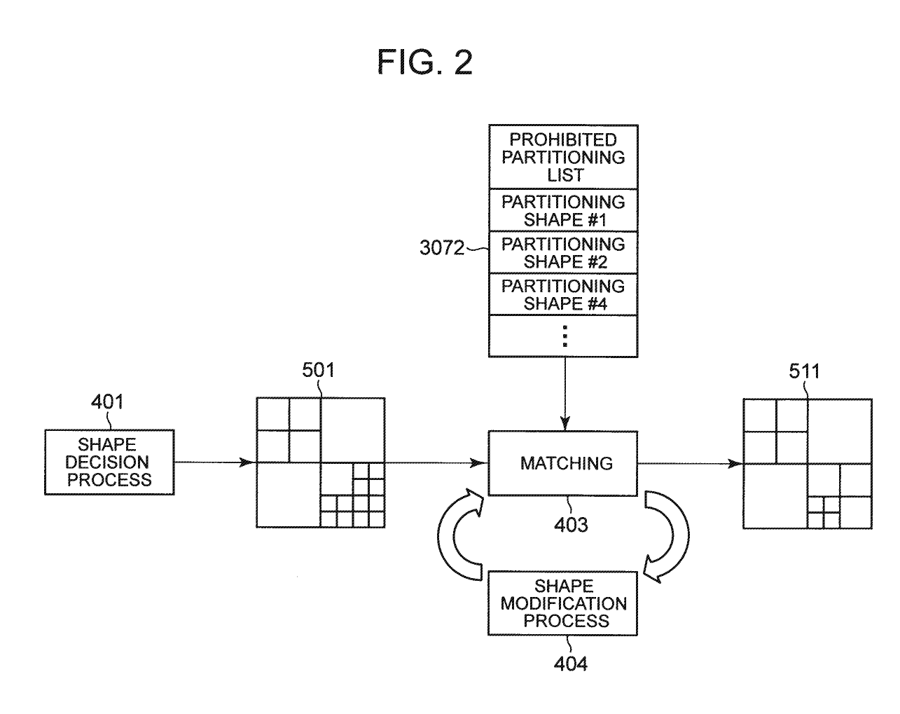

FIG. 2 is a conceptual diagram for describing the operation of the block structure decision circuit 307. The operation of the block structure decision circuit 307 is described below, with reference to FIGS. 1 and 2.

The optimum shape decision unit 3071 has the same function as the block structure decision unit 317 illustrated in FIG. 13. In detail, the optimum shape decision unit 3071 performs a shape decision process 401 of deciding the shape of a CU including a plurality of TUs so as to minimize the coding cost. An example of a shape 501 is illustrated in FIG. 2.

The utilized shape decision unit 3073 performs matching 403 to compare the TU quadtree structure decided by the optimum shape decision unit 3071 and the partitioning prohibition data in the prohibited partitioning list. In the case where the TU quadtree structure does not match with any of the partitioning prohibition data, the shape output unit 3074 outputs the data indicating the TU quadtree structure decided by the optimum shape decision unit 3071. Data of partitioning shapes #1, #2, and #4 are illustrated as examples of partitioning prohibition data in FIG. 2.

In the case where the TU quadtree structure matches with any of the partitioning prohibition data, the utilized shape decision unit 3073 performs a shape modification process 404 of modifying the TU quadtree structure decided by the optimum shape decision unit 3071 to such a TU quadtree structure that does not infringe the processing time constraint. The shape output unit 3074 then outputs the data indicating the modified TU quadtree structure. An example of a shape 511 output from the shape output unit 3074 is illustrated in FIG. 2.

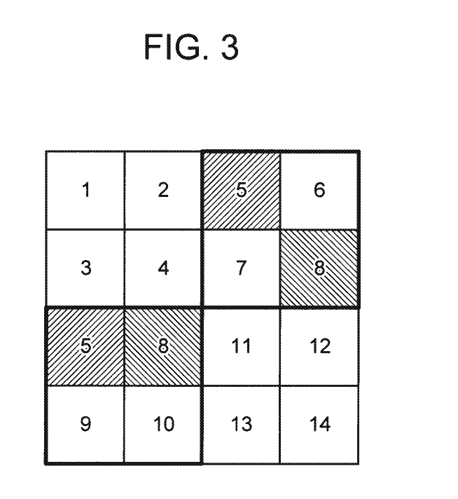

FIG. 3 is a diagram for describing dependence between blocks. FIG. 3 depicts a 16×16 block as an example. 16 rectangles in FIG. 3 each represent a 4×4 block. The number in each rectangle is the position in the order in which the blocks can be processed. The same two numbers (each of “5” and “8”) indicate that the two blocks can be processed simultaneously.

Looking at four 4×4 blocks in each of the upper left, upper right, lower left, and lower right portions (e.g. the upper left four blocks with the numbers “1”, “2”, “3”, and “4”), these four blocks cannot be processed simultaneously. Meanwhile, there are blocks that can be processed in parallel between the lower left four blocks and the upper right four blocks.

In the case where the compression processing unit is capable of processing a plurality of blocks in parallel, integrating the lower left four blocks into one large block (an 8×8 block in this example) does not much improve the processing time, and integrating the upper right four blocks into one large block does not much improve the processing time, in view of parallel processing.

Hence, according to the present invention, the shape modification process 404 is performed to integrate a plurality of blocks with a high degree of improvement in processing time into a large block.

The following describes specific examples of the process by the block structure decision circuit 307. In each exemplary embodiment, the compression processing unit is capable of processing (e.g. the process in the part enclosed by the dashed lines in FIG. 13) 32×32 blocks, 16×16 blocks, and 8×8 blocks, and capable of processing 4×4 blocks in parallel. In other words, the compression processing unit includes two lines of circuit for 4×4 blocks.

Note that such a structure of the compression processing unit is merely one example, and the range of parallel processibility may be widened.

### Exemplary Embodiment 1

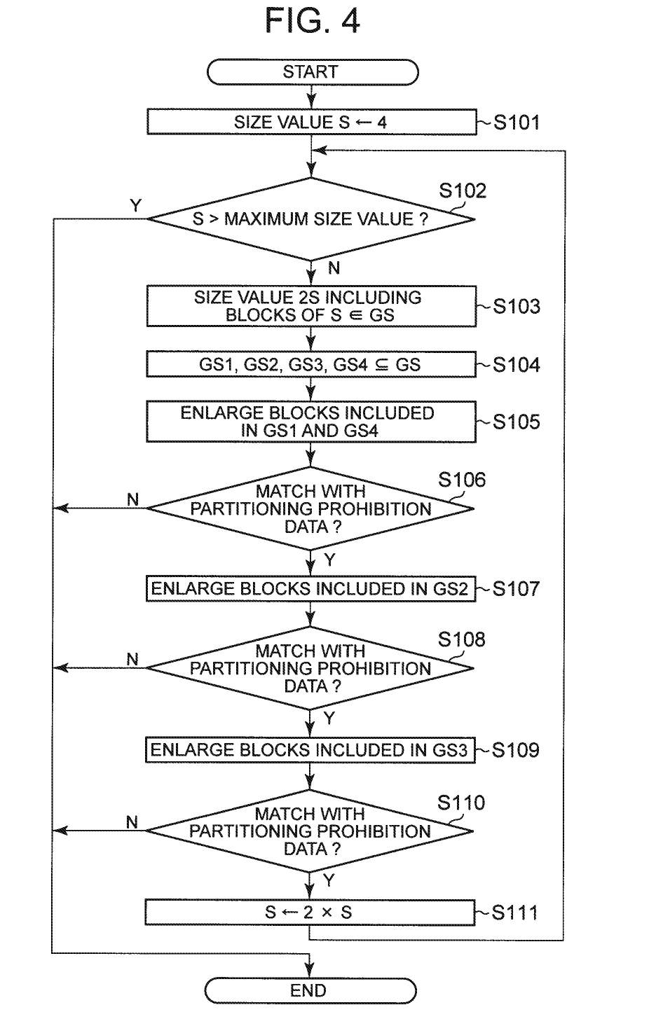

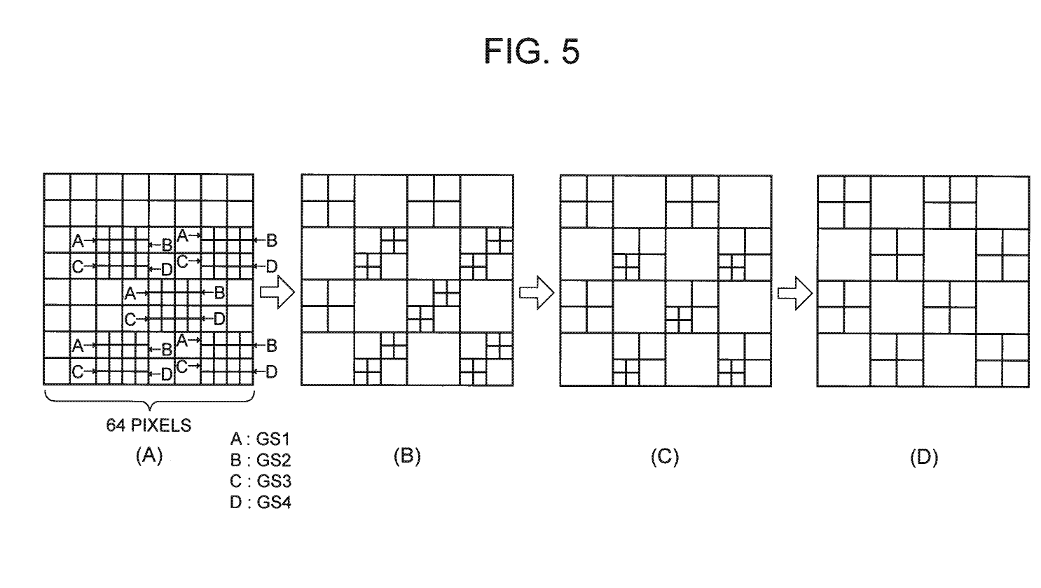

FIG. 4 is a flowchart depicting the operation of the utilized shape decision unit 3073 in the block structure decision circuit 307 in Exemplary Embodiment 1. FIG. 5 is an explanatory diagram depicting an example of the progress of the process by the utilized shape decision unit 3073. The process of modifying the TU quadtree structure by the utilized shape decision unit 3073 is described below, with reference to FIGS. 4 and 5. In detail, the following describes the operation of the utilized shape decision unit 3073 in the case where the TU quadtree structure decided by the optimum shape decision unit 3071 matches with the structure indicated by any of the partitioning prohibition data in the prohibited partitioning list.

The utilized shape decision unit 3073 first sets a size value S to 4 (step S101). Note that the size value S takes the value of 4, 8, or 16. The size value S indicates the size of a S×S block.

In the case where the size value S does not exceed the maximum size value (16 in this exemplary embodiment) (step S102), the utilized shape decision unit 3073 specifies a set GS whose elements are blocks of the size value 2S (2×S: 8 in this example) including blocks of the size value S (4 in this example) in the TU quadtree structure (partitioning shape) decided by the optimum shape decision unit 3071 (step S103).

In the example illustrated in (A) of FIG. 5, GS has 20 (=5×4) elements.

The utilized shape decision unit 3073 then divides GS into four subsets of blocks of the size value 2S (step S104). The set of the upper left blocks is GS1 (the set of blocks designated as “A” in (A) of FIG. 5). The set of the upper right blocks is GS2 (the set of blocks designated as “B” in (A) of FIG. 5). The set of the lower left blocks is GS3 (the set of blocks designated as “C” in (A) of FIG. 5)). The set of the lower right blocks is GS4 (the set of blocks designated as “D” in (A) of FIG. 5).

The utilized shape decision unit 3073 enlarges all blocks included in GS1 and GS4 by one step (step S105). One step larger than the current step is 8 with respect to 4, 16 with respect to 8, and 32 with respect to 16. In this example, all blocks included in GS1 and GS4 are modified to 8×8 blocks. The partitioning shape after the process of step S105 is illustrated as an example in (B) of FIG. 5).

The utilized shape decision unit 3073 determines whether or not the data indicating the modified partitioning shape matches with any of the partitioning prohibition data (step S106). In the case where the data does not match with any of the partitioning prohibition data, the process ends. In this case, the shape modified by the process of step S105 is the TU quadtree structure output from the shape output unit 3074.

In the case where the data indicating the modified partitioning shape matches with any of the partitioning prohibition data, the utilized shape decision unit 3073 enlarges all blocks included in GS2 by one step (step S107). In this example, all blocks included in GS2 are modified to 8×8 blocks. The partitioning shape after the process of step S107 is illustrated as an example in (C) of FIG. 5.

The utilized shape decision unit 3073 determines whether or not the data indicating the modified partitioning shape matches with any of the partitioning prohibition data (step S108). In the case where the data does not match with any of the partitioning prohibition data, the process ends. In this case, the shape modified by the process of step S107 is the TU quadtree structure output from the shape output unit 3074.

In the case where the data indicating the modified partitioning shape matches with any of the partitioning prohibition data, the utilized shape decision unit 3073 enlarges all blocks included in GS3 by one step (step S109). In this example, all blocks included in GS3 are modified to 8×8 blocks. The partitioning shape after the process of step S109 is illustrated as an example in (D) of FIG. 5.

The utilized shape decision unit 3073 determines whether or not the data indicating the modified partitioning shape matches with any of the partitioning prohibition data (step S110). In the case where the data does not match with any of the partitioning prohibition data, the process ends. In this case, the shape modified by the process of step S109 is the TU quadtree structure output from the shape output unit 3074.

In the case where the data indicating the modified partitioning shape matches with any of the partitioning prohibition data, the utilized shape decision unit 3073 modifies the size value to 2S (step S111), and returns to the state to perform the process of step S102.

If only blocks of the same size such as 4×4 blocks can be processed in parallel, the process of steps S107 and S108 and the process of steps S109 and S110 may be performed in reverse order, as mentioned later.

In this exemplary embodiment, a plurality of blocks with a high degree of improvement in processing time (the upper left blocks and the lower right blocks) are integrated into large blocks with priority. Only when the processing time constraint is still infringed in this state, a plurality of blocks that benefit from the effect of parallel processing are integrated into large blocks. This prevents a decrease in image quality caused by modification of the TU quadtree structure.

### Exemplary Embodiment 2

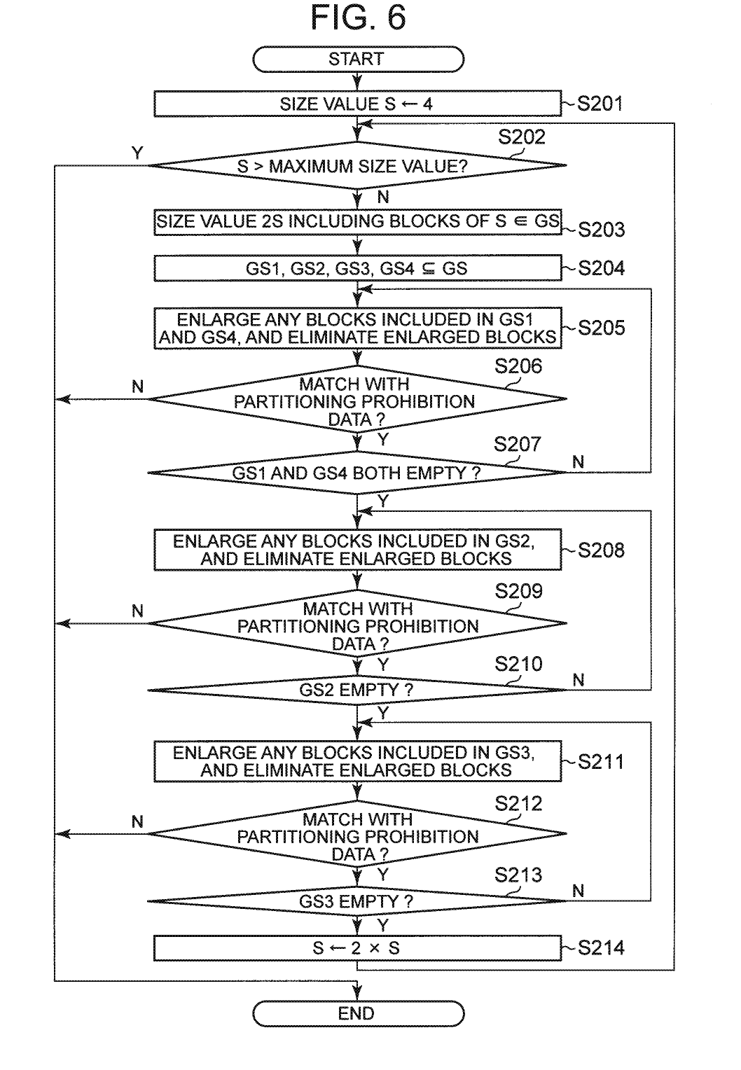

FIG. 6 is a flowchart depicting the operation of the utilized shape decision unit 3073 in the block structure decision circuit 307 in Exemplary Embodiment 2. The process of modifying the TU quadtree structure by the utilized shape decision unit 3073 is described below, with reference to FIGS. 5 and 6. In detail, the following describes the operation of the utilized shape decision unit 3073 in the case where the TU quadtree structure decided by the optimum shape decision unit 3071 matches with the structure indicated by any of the partitioning prohibition data in the prohibited partitioning list.

The utilized shape decision unit 3073 first sets a size value S to 4 (step S201).

In the case where the size value S does not exceed the maximum size value (16 in this exemplary embodiment) (step S202), the utilized shape decision unit 3073 specifies a set GS whose elements are blocks of the size value 2S (8 in this example) including blocks of the size value S (4 in this example) in the TU quadtree structure (partitioning shape) decided by the optimum shape decision unit 3071 (step S203).

In the example illustrated in (A) of FIG. 5, GS has 20 (=5×4) elements.

The utilized shape decision unit 3073 then divides GS into four subsets of blocks of the size value 2S (step S204). The set of the upper left blocks is GS1 (the set of blocks designated as “A” in (A) of FIG. 5). The set of the upper right blocks is GS2 (the set of blocks designated as “B” in (A) of FIG. 5). The set of the lower left blocks is GS3 (the set of blocks designated as “C” in (A) of FIG. 5). The set of the lower right blocks is GS4 (the set of blocks designated as “D” in (A) of FIG. 5).

The utilized shape decision unit 3073 enlarges any blocks out of the blocks included in GS1 and GS4 by one step, and excludes the enlarged blocks from GS1 or GS4 (step S205). In this example, any four 4×4 blocks out of the blocks included in GS1 and GS4 are modified to an 8×8 block. In step S205, the utilized shape decision unit 3073 enlarges blocks other than the blocks already subjected to the process of step S205.

The utilized shape decision unit 3073 determines whether or not the data indicating the modified partitioning shape matches with any of the partitioning prohibition data (step S206). In the case where the data does not match with any of the partitioning prohibition data, the process ends. In this case, the shape modified by the process of step S205 is the TU quadtree structure output from the shape output unit 3074.

The utilized shape decision unit 3073 determines whether or not GS1 and GS4 are empty sets (whether or not all elements are excluded) (step S207). In the case where any of GS1 and GS4 is not an empty set, the utilized shape decision unit 3073 returns to step S205.

In the case where GS1 and GS4 are empty sets, the utilized shape decision unit 3073 enlarges any blocks out of the blocks included in GS2 by one step, and excludes the enlarged blocks from GS2 (step S208).

The utilized shape decision unit 3073 determines whether or not the data indicating the modified partitioning shape matches with any of the partitioning prohibition data (step S209). In the case where the data does not match with any of the partitioning prohibition data, the process ends. In this case, the shape modified by the process of step S208 is the TU quadtree structure output from the shape output unit 3074.

The utilized shape decision unit 3073 determines whether or not GS2 is an empty set (step S210). In the case where GS2 is not an empty set, the utilized shape decision unit 3073 returns to step S208.

In the case where GS2 is an empty set, the utilized shape decision unit 3073 enlarges any blocks out of the blocks included in GS3 by one step, and excludes the enlarged blocks from GS3 (step S211).

The utilized shape decision unit 3073 determines whether or not the data indicating the modified partitioning shape matches with any of the partitioning prohibition data (step S212). In the case where the data does not match with any of the partitioning prohibition data, the process ends. In this case, the shape modified by the process of step S211 is the TU quadtree structure output from the shape output unit 3074.

The utilized shape decision unit 3073 determines whether or not GS3 is an empty set (step S213). In the case where GS3 is not an empty set, the utilized shape decision unit 3073 returns to step S211.

If only blocks of the same size such as 4×4 blocks can be processed in parallel, the process of steps S208 to S210 and the process of steps S211 to S213 may be performed in reverse order, as mentioned later.

In the case where GS3 is an empty set, the utilized shape decision unit 3073 modifies the size value to 2S (step S214), and returns to the state to perform the process of step S202.

In this exemplary embodiment, too, a plurality of blocks with a high degree of improvement in processing time (the upper left blocks and the lower right blocks) are integrated into large blocks with priority. Only when the processing time constraint is still infringed in this state, a plurality of blocks that benefit from the effect of parallel processing are integrated into large blocks. This prevents a decrease in image quality caused by modifying the TU quadtree structure.

Moreover, in this exemplary embodiment, the utilized shape decision unit 3073 performs the process of increasing the block size on the elements of the sets GS1, GS2, GS3, and GS4 one at a time, so that the area in which the size is increased is reduced as compared with Exemplary Embodiment 1. This further enhances the effect of preventing a decrease in image quality.

### Exemplary Embodiment 3

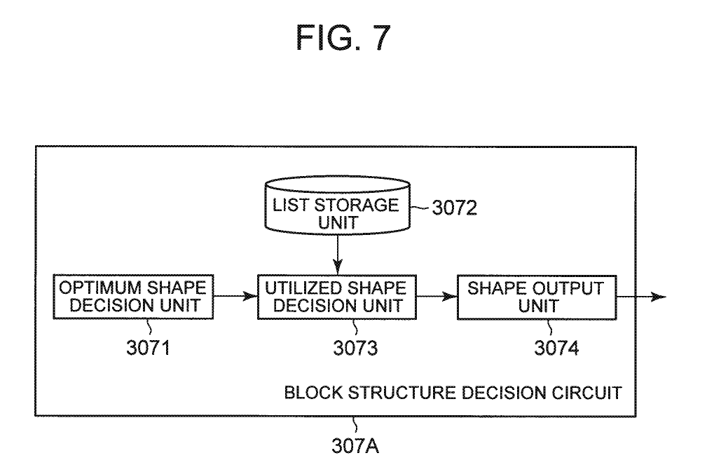

FIG. 7 is a block diagram depicting another exemplary embodiment of the block structure decision circuit according to the present invention. A block structure decision circuit 307A illustrated in FIG. 7 includes: an optimum shape decision unit 3071, a list storage unit 3072 storing a prohibited partitioning list and a processing time list, an utilized shape decision unit 3073, and a shape output unit 3074. The block structure decision circuit 307A is applicable to the video coding circuit illustrated as an example in FIG. 13. In the application, the block structure decision circuit 307A is implemented in place of the block structure decision unit 317.

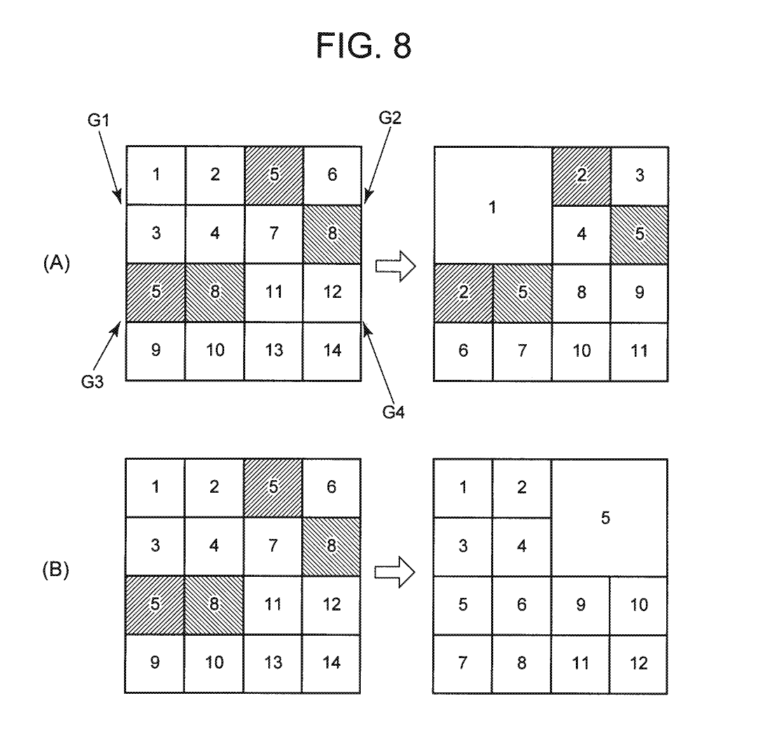

(A) and (B) of FIG. 8 are diagrams for describing processing time reductions. 16 rectangles in FIG. 8 each represent a 4×4 block. The number in each rectangle is the position in the order in which the blocks can be processed. The same two numbers (each of “2”, “5”, and “8” diagonally shaded in FIG. 8) indicate that the two blocks can be processed simultaneously. The upper left four blocks are denoted by G1. The upper right four blocks are denoted by G2. The lower left four blocks are denoted by G3. The lower right four blocks are denoted by G4.

Let T_{LCU} be the processing time of a LCU in the compression processing unit, and T_{S} be the processing time of a block of each size (S=4, 8, 16, 32: T₄ is the processing time of a 4×4 block, T₈ is the processing time of an 8×8 block, T₁₆ is the processing time of a 16×16 block, and T₃₂ is the processing time of a 32×32 block). The compression processing unit includes two lines of circuit at least for 4×4 blocks.

In the case where S=4, increasing the size of G1 or G4 to 8×8 does not affect parallel processing of 4×4 blocks in the compression processing unit. While (A) of FIG. 8 depicts an example of increasing the size of G1 to 8×8, two 4×4 blocks in G2 and G3 can be processed in parallel regardless of whether or not the size of G1 is modified to 8×8.

In the case where the size of G1 is not modified to 8×8, T_{LCU}=14*T_{S} (S=4). In the case where the size of G1 is modified to 8×8, T_{LCU}=10*T_{S}+T_{2S}. Let T_{d} be the processing time reduction in the case where the block size is modified. In the example illustrated in (A) of FIG. 8, T_{d}=4*T_{S}−T_{2S}.

When the size of G2 is increased to 8×8, there are no 4×4 blocks that can be processed in parallel in G2 and G3, as illustrated in (B) of FIG. 8. Thus, in the case where the compression processing unit includes two lines of circuit for 4×4 blocks (in the case where the compression processing unit is capable of parallel processing of only 4×4 blocks), the parallel processing performance may decrease if the block size is increased. Besides, in the case where the compression processing unit is capable of parallel processing of only blocks of the same size such as 4×4 blocks, the processing time reduction is the same regardless of whether the size of G2 is increased first or the size of G3 is increased first.

In the case where the size of G2 is not modified to 8×8, T_{LCU}=14*T_{S}. In the case where tie size of G2 is modified to 8×8, T_{LCU}=12*T_{S}+T_{2S}. In the example illustrated in (B) of FIG. 8, T_{d}=2*T_{S}−T_{2S}.

On the other hand, in the case where the compression processing unit is capable of parallel processing of not only 4×4 blocks (for example, the compression processing unit is capable of parallel processing of 4×4 blocks and 8×8 blocks), the processing time is reduced when the size of G2 is increased to 8×8. In detail, if the compression processing unit is capable of parallel processing of the blocks with the number “5” (a 4×4 block and an 8×8 block) in the example illustrated on the right side of (B) of FIG. 8, T_{LCU}=11*T_{S}+T_{2S}. Hence, T_{d}=3*T_{S}−T_{2S}, which is greater than 2*T_{S}−T_{2S}.

Let T_{bad} be the processing time of a whole LCU corresponding to a TU quadtree structure indicated by partitioning prohibition data. If the total processing time reduction/T_{d} in the case where the block size is increased is greater than (T_{bad}−T_{LCU}) (i.e. (T_{bad}−ΣT_{d})<T_{LCU}), the processing time constraint is not infringed.

Hereafter, (T_{bad} ΣT_{d})<T_{LCU} is referred to as a “conditional expression”, where T_{LCU} corresponds to a target value.

In this exemplary embodiment, the list storage unit 3072 stores, in addition to the prohibited partitioning list, the processing time list including processing time data (indicating T_{bad}) corresponding to each piece of partitioning prohibition data (see FIG. 7).

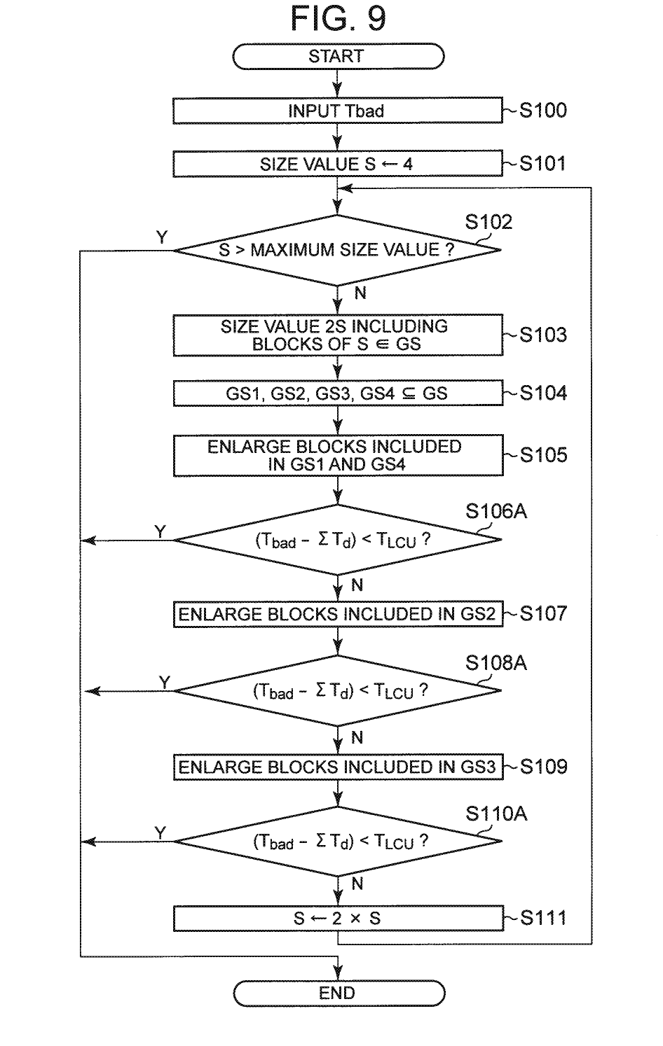

FIG. 9 is a flowchart depicting the operation of the utilized shape decision unit 3073 in Exemplary Embodiment 3. The process of modifying the TU quadtree structure by the utilized shape decision unit 3073 is described below, with reference to FIGS. 5 and 9. In detail, the following describes the operation of the utilized shape decision unit 3073 in the case where the TU quadtree structure decided by the optimum shape decision unit 3071 matches with the structure indicated by any of the partitioning prohibition data in the prohibited partitioning list.

The utilized shape decision unit 3073 inputs T_{bad} of the partitioning prohibition data in the prohibited partitioning list indicating the structure that matches with the TU quadtree structure decided by the optimum shape decision unit 3071 (step S100). The utilized shape decision unit 3073 also sets a size value S to 4 (step S101).

In the case where the size value S does not exceed the maximum size value (16 in this exemplary embodiment) (step S102), the utilized shape decision unit 3073 specifies a set GS whose elements are blocks of the size value 2S (2×S: 8 in this example) including blocks of the size value S (4 in this example) in the TU quadtree structure (partitioning shape) decided by the optimum shape decision unit 3071 (step S103).

In the example illustrated in (A) of FIG. 5, GS has 20 (=5×4) elements.

The utilized shape decision unit 3073 then divides GS into four subsets of blocks of the size value 2S (step S104). The set of the upper left blocks is GS1 (the set of blocks designated as “A” in (A) of FIG. 5). The set of the upper right blocks is GS2 (the set of blocks designated as “B” in (A) of FIG. 5). The set of the lower left blocks is GS3 (the set of blocks designated as “C” in (A) of FIG. 5). The set of the lower right blocks is GS4 (the set of blocks designated as “D” in (A) of FIG. 5).

The utilized shape decision unit 3073 enlarges all blocks included in GS1 and GS4 by one step (step S105). In this example, all blocks included in GS1 and GS4 are modified to 8×8 blocks.

The utilized shape decision unit 3073 calculates ΣT_{d} based on the data indicating the partitioning shape before and after the modification, subtracts ΣT_{d} from T_{bad} obtained by the process of step S100, and determines whether or not the conditional expression is satisfied (step S106A). In the case where the conditional expression is satisfied, the process ends. In this case, the shape modified by the process of step S105 is the TU quadtree structure output from the shape output unit 3074.

In the case where the conditional expression is not satisfied, the utilized shape decision unit 3073 enlarges all blocks included in GS2 by one step (step S107). In this example, all blocks included in GS2 are modified to 8×8 blocks.

The utilized shape decision unit 3073 calculates ΣT_{d} based on the data indicating the partitioning shape before and after the modification, subtracts ΣT_{d} from T_{bad} obtained by the process of step S100, and determines whether or not the conditional expression is satisfied (step S108A). In the case where the conditional expression is satisfied, the process ends. In this case, the shape modified by the process of step S107 is the TU quadtree structure output from the shape output unit 3074.

In the case where the conditional expression is not satisfied, the utilized shape decision unit 3073 enlarges all blocks included in GS3 by one step (step S109). In this example, all blocks included in GS3 are modified to 8×8 blocks.

The utilized shape decision unit 3073 calculates ΣT_{d} based on the data indicating the partitioning shape before and after the modification, subtracts ΣT_{d} from T_{bad} obtained by the process of step S100, and determines whether or not the conditional expression is satisfied (step S110A). In the case where the conditional expression is satisfied, the process ends. In this case, the shape modified by the process of step S109 is the TU quadtree structure output from the shape output unit 3074.

In the case where the conditional expression is not satisfied, the utilized shape decision unit 3073 modifies the size value to 2S (step S111), and returns to the state to perform the process of step S102.

If only blocks of the same size such as 4×4 blocks can be processed in parallel, the process of steps S107 and S108A and the process of steps S109 and S110A may be performed in reverse order, as mentioned earlier.

In this exemplary embodiment, too, a plurality of blocks with a high degree of improvement in processing time (the upper left blocks and the lower right blocks) are integrated into large blocks with priority. Only when the processing time constraint is still infringed in this state, a plurality of blocks that benefit from the effect of parallel processing are integrated into large blocks. This prevents a decrease in image quality caused by modifying the TU quadtree structure.

Moreover, in this exemplary embodiment, the utilized shape decision unit 3073 does not perform matching between the data indicating the modified shape (TU quadtree structure) and the partitioning prohibition data during the process of steps S101 to S111. This shortens the time required to decide such a TU quadtree structure that does not infringe the processing time constraint, as compared with Exemplary Embodiment 1.

### Exemplary Embodiment 4

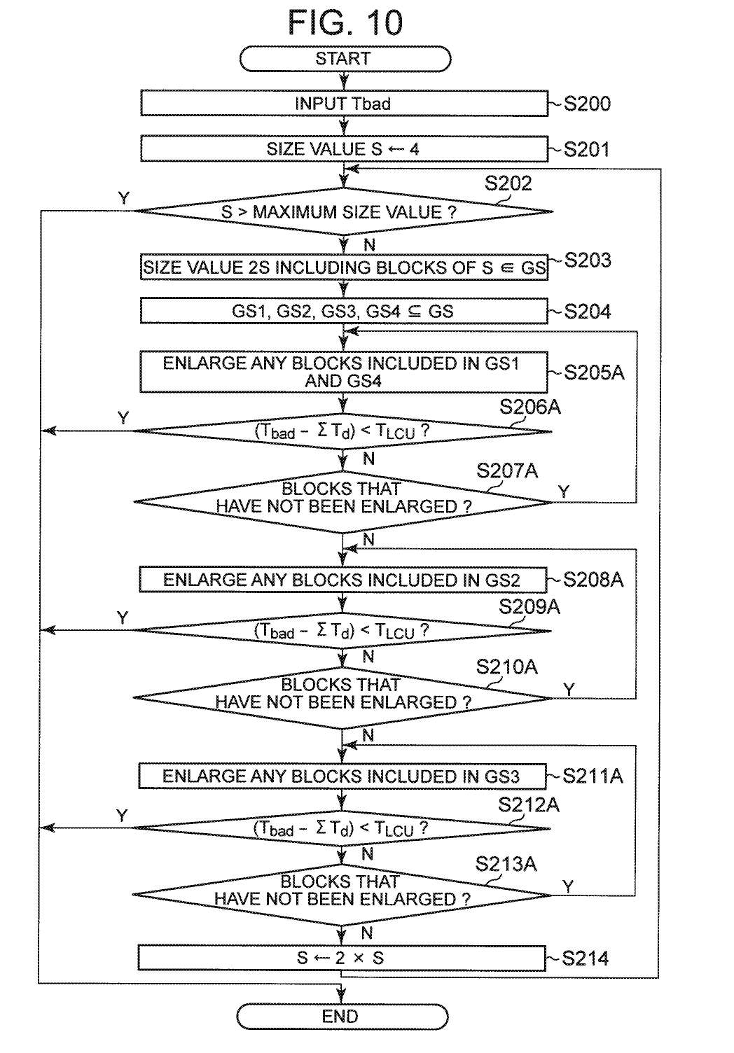

FIG. 10 is a flowchart depicting the operation of the utilized shape decision unit 3073 in the block structure decision circuit 307 in Exemplary Embodiment 4. The process of modifying the TU quadtree structure by the utilized shape decision unit 3073 is described below, with reference to FIGS. 5 and 10. In detail, the following describes the operation of the utilized shape decision unit 3073 in the case where the TU quadtree structure decided by the optimum shape decision unit 3071 matches with the structure indicated by any of the partitioning prohibition data in the prohibited partitioning list.

In this exemplary embodiment, the list storage unit 3072 stores, in addition to the prohibited partitioning list, the processing time list including processing time data (indicating T_{bad}) corresponding to each piece of partitioning prohibition data, as in Exemplary Embodiment 3.

The utilized shape decision unit 3073 inputs T_{bad} of the partitioning prohibition data in the prohibited partitioning list indicating the structure that matches with the TU quadtree structure decided by the optimum shape decision unit 3071 (step S200). The utilized shape decision unit 3073 also sets a size value S to 4 (step S201).

In the case where the size value S does not exceed the maximum size value (16 in this exemplary embodiment) (step S202), the utilized shape decision unit 3073 specifies a set GS whose elements are blocks of the size value 2S (8 in this example) including blocks of the size value S (4 in this example) in the TU quadtree structure (partitioning shape) decided by the optimum shape decision unit 3071 (step S203).

In the example illustrated in (A) of FIG. 5), GS has 20 (=5×4) elements.

The utilized shape decision unit 3073 then divides GS into four subsets of blocks of the size value 2S (step S204). The set of the upper left blocks is GS1 (the set of blocks designated as “A” in (A) of FIG. 5). The set of the upper right blocks is GS2 (the set of blocks designated as “B” in (A) of FIG. 5). The set of the lower left blocks is GS3 (the set of blocks designated as “C” in (A) of FIG. 5). The set of the lower right blocks is GS4 (the set of blocks designated as “D” in (A) of FIG. 5).

The utilized shape decision unit 3073 enlarges any blocks out of the blocks included in GS1 and GS4 by one step (step S205A). The utilized shape decision unit 3073 then calculates, for the enlarged blocks, ΣT_{d} based on the data indicating the partitioning shape before and after the modification, subtracts ΣT_{d} from T_{bad} obtained by the process of step S200, and determines whether or not the conditional expression is satisfied (step S206A). In the case where the conditional expression is satisfied, the process ends. In this case, the shape modified by the process of the immediately previous step S205A is the TU quadtree structure output from the shape output unit 3074.

In the case where the conditional expression is not satisfied, the utilized shape decision unit 3073 determines whether or not there are blocks that have not been enlarged (step S207A). In the case where there are blocks that have not been enlarged, the utilized shape decision unit 3073 returns to step S205A. In the case where there are no blocks that have not been enlarged, the utilized shape decision unit 3073 advances to step S208A.

In the case where the utilized shape decision unit 3073 determines that the conditional expression is not satisfied in the process of step S206A, the blocks enlarged by the process of step S205A are modified back to the original size. In other words, in the process of step S205A, the utilized shape decision unit 3073 does not actually enlarged, but performs a trial process of increasing the block size for the determination process of step S206A. Moreover, in the process of step S205A, the utilized shape decision unit 3073 tries to enlarge any blocks other than the blocks already subjected to the trial process.

In step S208A, the utilized shape decision unit 3073 performs a trial process of increasing the size of any blocks out of the blocks included in GS2 by one step. The utilized shape decision unit 3073 then calculates, for the enlarged blocks, ΣT_{d} based on the data indicating the partitioning shape before and after the modification, subtracts ΣT_{d} from T_{bad} obtained by the process of step S200, and determines whether or not the conditional expression is satisfied (step S209A). In the case where the conditional expression is satisfied, the process ends. In this case, the shape modified by the process of the immediately previous step S208A is the TU quadtree structure output from the shape output unit 3074.

In the case where the conditional expression is not satisfied, the utilized shape decision unit 3073 determines whether or not there are blocks that have not been enlarged (step S210A). In the case where there are blocks that have not been enlarged, the utilized shape decision unit 3073 returns to step S208A. In the case where there are no blocks that have not been enlarged, the utilized shape decision unit 3073 advances to step S211A.

In step S211A, the utilized shape decision unit 3073 performs a trial process of increasing the size of any blocks out of the blocks included in GS3 by one step. The utilized shape decision unit 3073 then calculates, for the enlarged blocks, ΣT_{d} based on the data indicating the partitioning shape before and after the modification, subtracts ΣT_{d} from T_{bad} obtained by the process of step S200, and determines whether or not the conditional expression is satisfied (step S212A). In the case where the conditional expression is satisfied, the process ends. In this case, the shape modified by the process of the immediately previous step S211A is the TU quadtree structure output from the shape output unit 3074.

In the case where the conditional expression is not satisfied, the utilized shape decision unit 3073 determines whether or not there are blocks that have not been enlarged (step S213A). In the case where there are blocks that have not been enlarged, the utilized shape decision unit 3073 returns to step S211A. In the case where there are no blocks that have not been enlarged, the utilized shape decision unit 3073 modifies the size value to 2S (step S214), and returns to the state to perform the process of step S202.

If only blocks of the same size such as 4×4 blocks can be processed in parallel, the process of steps S208A to S210A and the process of steps S211A to S213A may be performed in reverse order, as mentioned earlier.

In this exemplary embodiment, too, a plurality of blocks with a high degree of improvement in processing time (the upper left blocks and the lower right blocks) are integrated into large blocks with priority. Only when the processing time constraint is still infringed in this state, a plurality of blocks that benefit from the effect of parallel processing are integrated into large blocks. This prevents a decrease in image quality caused by modifying the TU quadtree structure.

Moreover, in this exemplary embodiment, the utilized shape decision unit 3073 does not perform matching between the data indicating the modified shape (TU quadtree structure) and the partitioning prohibition data during the process of steps S201 to S214. This shortens the time required to decide such a TU quadtree structure that does not infringe the processing time constraint, as compared with Exemplary Embodiment 2.

Furthermore, in this exemplary embodiment, the utilized shape decision unit 3073 performs the trial process of increasing the block size on the elements of the sets GS1, GS2, GS3, and GS4 one at a time, so that the area in which the size is increased is reduced as compared with Exemplary Embodiment 3. This further enhances the effect of preventing a decrease in image quality.

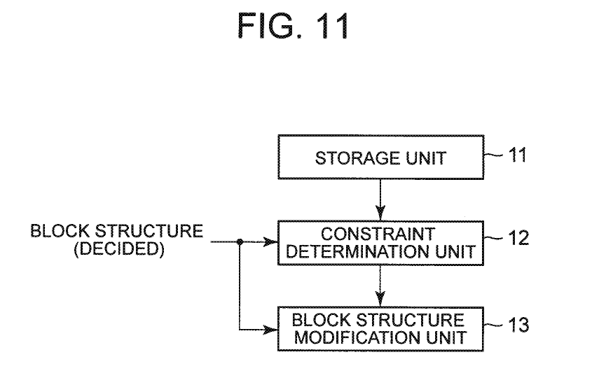

FIG. 11 is a block diagram depicting main parts of the block structure decision circuit according to the present invention. As illustrated in FIG. 11, the block structure decision circuit includes: a storage unit 11 (for example, realized by the list storage unit 3072 illustrated in FIGS. 1 and 7) in which constraint data (for example, the prohibited partitioning list illustrated in FIGS. 1 and 7 and the processing time list illustrated in FIG. 7) relating to a constraint on processing time for processing the block structure is set; a constraint determination unit 12 (for example, realized by the utilized shape decision unit 3073 illustrated in FIGS. 1 and 7) for determining whether or not the decided block structure (for example, the TU quadtree structure decided by the optimum shape decision unit 3071 illustrated in FIGS. 1 and 7) infringes the constraint specified by the constraint data; and a block structure modification unit 13 (for example, realized by the utilized shape decision unit 3073 illustrated in FIGS. 1 and 7) for modifying the decided block structure not to infringe the constraint, in the case where the constraint determination unit 12 determines that the decided block structure infringes the constraint.

As an example, a plurality of steps are defined for a plurality of sizes (for example, 32×32 block size, 16×16 block size, 8×8 block size, and 4×4 block size), and the block structure modification unit 13 increases the size in the decided block structure by one step (for example, 8×8 block size with respect to 4×4 block size).

Preferably, the block structure modification unit 13 increases the size in units (for example, G1 and G4 illustrated in FIG. 8) that cannot be processed in parallel (for example, the subsequent compression processing unit cannot start processing the units simultaneously) by one step, with priority.

For example, the constraint data is data (partitioning prohibition data in the above-mentioned example) indicating a block structure that infringes the constraint on processing time. Moreover, the constraint data may include processing time data (for example, T_{bad}) of processing time for processing the block structure that infringes the constraint on processing time, and the block structure modification unit 13 may modify the decided block structure so that a difference between the processing time indicated by the processing time data and processing time (for example, ΣT_{d}) for processing the modified block structure is less than a target value (for example, T_{LCU}).

Although the present invention has been described with reference to the above exemplary embodiments and examples, the present invention is not limited to the above exemplary embodiments and examples. Various changes understandable by those skilled in the art can be made to the structures and details of the present invention within the scope of the present invention.

This application claims priority based on Japanese Patent Application No. 2013-218825 filed on Oct. 22, 2013, the disclosure of which is incorporated herein in its entirety.

### REFERENCE SIGNS LIST

11 storage unit
12 constraint determination unit
13 block structure modification unit
301 transformer
302 quantizer
303 entropy coding unit
304 inverse quantizer/inverse transformer
305 buffer
306 prediction unit
307, 307A block structure decision circuit
317 block structure decision unit
3071 optimum shape decision unit
3072 list storage unit
3073 utilized shape decision unit
3074 shape output unit

What is claimed is:

1. A block structure decision circuit for deciding a block structure including units formed by hierarchically dividing a block, the block structure decision circuit comprising:
a storage unit in which constraint data relating to a constraint on processing time for processing the block structure is set;
a constraint determination unit which determines whether or not the decided block structure infringe the constraint specified by the constraint data; and
a block structure modification unit which modifies the decided block structure to satisfy the constraint, in the case where the constraint determination unit determines that the decided block structure does not satisfy the constraint.

2. The block structure decision circuit according to claim 1, wherein a plurality of sizes for the unit are defined, and
wherein the block structure modification unit increases the size of the unit in the decided block structure by one step.

3. The block structure decision circuit according to claim 2, wherein the block structure modification unit increases the size of the units that cannot be processed in parallel by one step, with priority.

4. The block structure decision circuit according to claim 1, wherein the constraint data is data indicating a block structure that infringes the constraint on processing time.

5. The block structure decision circuit according to claim 4, wherein the constraint data includes processing time data of processing time for processing the block structure that infringes the constraint on processing time, and
wherein the block structure modification unit modifies the decided block structure so that a difference between the processing time indicated by the processing time data and processing time for processing the modified block structure is less than a target value.

6. A block structure decision method for deciding a block structure including units formed by hierarchically dividing a block, the block structure decision method comprising:
setting constraint data relating to a constraint on processing time for processing the block structure, in a storage unit beforehand;
determining whether or not the decided block structure infringes the constraint specified by the constraint data; and
changing the decided block structure not to infringe the constraint, in the case of determining that the decided block structure infringes the constraint.

7. The block structure decision method according to claim 6, comprising:
defining a plurality of steps for a size of the units; and
increasing a size of units in the decided block structure by one step.

8. The block structure decision method according to claim 7, comprising
increasing a size of units that cannot be processed in parallel by one step, with priority.

9. The block structure decision method according to claim 6, comprising
setting, as the constraint data, data indicating a block structure that infringes the constraint on processing time.

10. The block structure decision method according to claim 9, comprising:
setting, as the constraint data, processing time data of processing time for processing the block structure that infringes the constraint on processing time, and
changing the decided block structure so that a difference between the processing time indicated by the processing time data and processing time for processing the modified block structure is less than a target value.

11. The block structure decision circuit according to claim 2, wherein the constraint data is data indicating a block structure that infringes the constraint on processing time.

12. The block structure decision circuit according to claim 3, wherein the constraint data is data indicating a block structure that infringes the constraint on processing time.

13. The block structure decision method according to claim 7, comprising
setting, as the constraint data, data indicating a block structure that infringes the constraint on processing time.

14. The block structure decision method according to claim 8, comprising
setting, as the constraint data, data indicating a block structure that infringes the constraint on processing time.
